(19) United States
(12) Patent Application Publication
(10) Pub. No.: US 2006/0286860 A1
(43) Pub. Date: Dec. 21, 2006

(54) Serial advanced technology attachment cable

(75) Inventor: Zheng-Heng Sun, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/344,269

(22) Filed: Jan. 30, 2006

(30) Foreign Application Priority Data
Jun. 17, 2005 (CN) 200510035414.9

(51) Int. Cl. H01R 12/24

(52) U.S. Cl. 439/499

(57) ABSTRACT

A Serial Advanced Technology Attachment (SATA) cable includes a connector socket and a storage socket. Both the connector socket and the storage socket have a SATA receptacle and a power receptacle. The SATA receptacles of the connector socket and the storage socket are coupled with a signal wire. The power receptacles of the connector socket and the storage socket are coupled with a power wire. It is simple and economical to use the SATA cable for connecting a computer with a SATA data storage device.

### CROSS-REFERENCE TO RELATED APPLICATION

Relevant subject matter is disclosed in co-pending U.S. patent application entitled “SERIAL ADVANCED TECHNOLOGY ATTACHMENT CONNECTOR”, assigned to the same assignee with this application.

### BACKGROUND OF THE INVENTION

1. Field of the Invention

The present invention relates to an electric cable, and particularly to a Serial Advanced Technology Attachment (SATA) cable between a computer and a SATA data storage device.

2. General Background

Computers are widely used in the fields of E-commerce, E-business, Home network, Internet work station and so on. Each computer has a data storage center, e.g. hard disk, where computer software and business data information are saved. When the computer runs, the computer Central Processing Unit (CPU) continuously accesses the hard disk and retrieves data from the hard disk or stores data to the hard disk. For compatibility, the hard disk drive interfaces are standardized. There are many hard disk drive interface standards and the Small Computer System Interface (SCSI) families and Advanced Technology Attachment (ATA) families are the most famous in the last decade.

The parallel ATA specification has defined the standard storage interface for PCs since the early 1980s. Parallel ATA provides low cost, broad operating system support, and steady evolution. Over time, parallel ATA has continuously evolved to support higher speed and performance. However, due to several reasons, including performance headroom, cabling issues, and voltage tolerance requirements, a new storage interface known as Serial ATA (SATA) has recently been created.

SATA may combine software transparency, low cost, scalability, and design flexibility to overcome the limitations of parallel ATA. Point-to-point data rates of 1.5 Gbps may be attainable with SATA. Therefore, SATA connectors are usual components on the mother board of a computer.

What is needed is a SATA cable for connecting the computer with a SATA data storage device.

### SUMMARY

A SATA cable of a preferred embodiment includes a connector socket and a storage socket. Both the connector socket and the storage socket have a SATA receptacle and a power receptacle. The SATA receptacles of the connector socket and the storage socket are coupled with a signal wire, the power receptacles of the connector socket and the storage socket are coupled with a power wire.

It is simple and economical to use the SATA cable for connecting a computer with a SATA data storage device.

Other advantages and novel features will become more apparent from the following detailed description when taken in conjunction with the accompanying drawings, in which:

### BRIEF DESCRIPTION OF THE DRAWINGS

FIG. 1 is an isometric view of a SATA cable in accordance with a preferred embodiment of the present invention;

FIG. 2 is an isometric view of a socket of the SATA cable of FIG. 1; and

FIG. 3 is an isometric view of the SATA cable of FIG. 1 connecting a SATA connector with a SATA hard disk.

### DETAILED DESCRIPTION OF THE EMBODIMENT

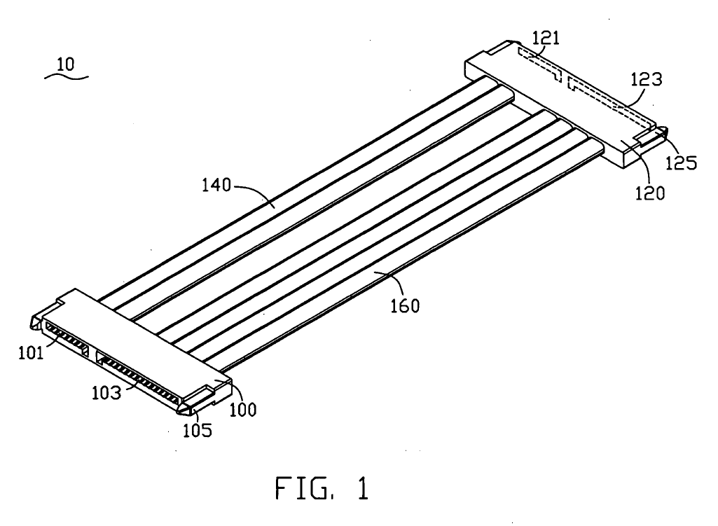

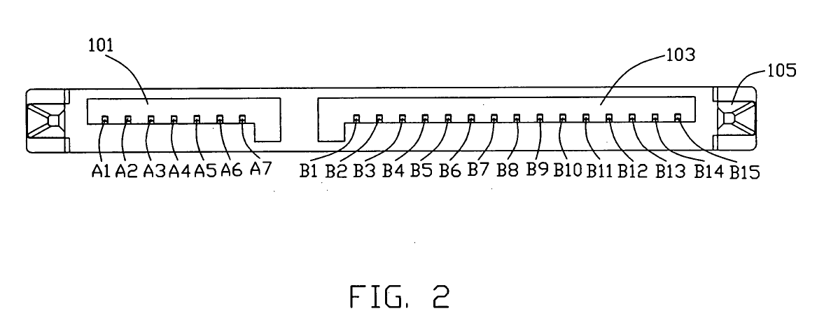

Referring to FIG. 1 and FIG. 2, a SATA cable 10 in accordance with a preferred embodiment of the present invention includes a connector socket 100 and a storage socket 120. The connector socket 100 includes a SATA receptacle 101 and a power receptacle 103. The storage socket 120 includes a SATA receptacle 121 and a power receptacle 123. The SATA receptacles 101 and 121 of the connector socket 100 and the storage socket 120 are coupled with a signal wire 140, the power receptacles 103 and 123 of the connector socket 100 and the storage socket 120 are coupled with a power wire 160.

The SATA receptacles 101 and 121 include a plurality of signal pins, the signals that the pins transmit are shown in following table:

| | PINS | DESCRIPTION |
|---|---|---|
| SATA | A1 | GND |
| RECEPTACLES | A2 | A+ |
| | A3 | A− |
| | A4 | GND |
| | A5 | B+ |
| | A6 | B− |
| | A7 | GND |

The power receptacles 103 and 123 include a plurality of signal pins, The signals that the pins transmit are shown in following table:

| | PINS | DESCRIPTION |
|---|---|---|
| POWER | B1 | — |
| RECEPTACLES | B2 | |
| | B3 | |
| | B4 | GND |
| | B5 | |
| | B6 | |
| | B7 | +5 V DC |
| | B8 | |
| | B9 | |
| | B10 | GND |
| | B11 | |
| | B12 | |
| | B13 | +12 V DC |
| | B14 | |
| | B15 | |

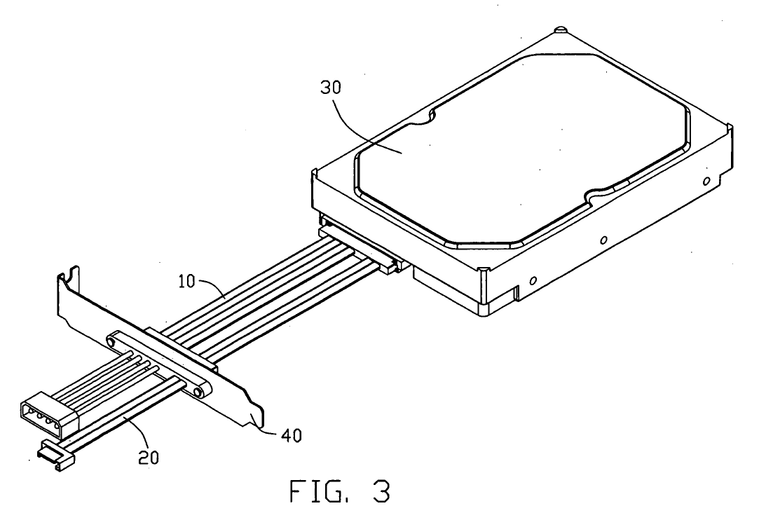

The connector socket 100 of the SATA cable 10 further includes a pair of pegs 105 at two opposite sides thereof. The storage socket 120 of the SATA cable 10 further includes a pair of pegs 125 at two opposite sides thereof. Referring to FIG. 3, the SATA cable 10 is applicable to a connective system of an electronic device like a computer. The connector socket 100 of the SATA cable 10 is mounted to a SATA connector 20 via the pegs 105 mating with corresponding notches of the SATA connector 20. The SATA connector 20 is mounted to the computer via a cover plate of the computer and is capable of further electrically connecting with a main process part like a motherboard and a power supply of the computer respectively by means of its attached wires extending inside the computer. The storage socket 120 of the SATA cable 10 is mounted to a SATA hard disk 30 via the pegs 125 mating with corresponding notches of the SATA hard disk 30. The configuration of the connector socket 100 is similar with the storage socket 120, therefore the connector socket 100 can be alternatively mounted to the SATA hard disk 30, and the storage socket 120 can be alternatively mounted to the SATA connector 20 as well.

The SATA cable 10 can bridge connect the SATA connector 20 with the SATA hard disk 30, and makes the signal transmission between a computer and a SATA storage simple.

It is to be understood, however, that even though numerous characteristics and advantages of the present embodiments have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A Serial Advanced Technology Attachment (SATA) cable comprising:
two sockets each comprising a SATA receptacle and a power receptacle; and
a plurality of signal wires and power wires connecting the sockets.

2. The SATA cable as claimed in claim 1, wherein each of the sockets selectively mates with one of a SATA connector and a storage device for bridge connecting the SATA connector and the storage device.

3. The SATA cable as claimed in claim 2, wherein each of the sockets includes a pair of pegs at two opposite sides thereof for mating with one of the SATA connector and the storage device.

4. A Serial Advanced Technology Attachment (SATA) device comprising:
a SATA connector;
a storage device; and
a SATA cable connecting the SATA connector and the storage device, the SATA cable comprising two sockets and a plurality of wires connecting the sockets; wherein each of the sockets selectively mates with one of the SATA connector and the storage device.

5. The SATA device as claimed in claim 4, wherein each of the sockets comprises a SATA receptacle and a power receptacle.

6. The SATA device as claimed in claim 4, wherein each of the sockets includes a pair of pegs at two opposite sides thereof for mating with one of the SATA connector and the storage device.

7. A connective system of an electronic device comprising:
a main process part of said electronic device;
a part device for said electronic device available to be installed at an outside of said electronic device for functional extension of said electronic device;
a cover plate of said electronic device installable around said electronic device so as to isolate said electronic device from said outside thereof, said cover plate defining an electrical connection thereon to be capable of establishing signal communication with said main process part; and
a cable electrically connectable between said electrical connection of said cover plate and said part device so as to establish signal communication between said part device and said main process part through said electrical connection.

8. The system as claimed in claim 7, wherein said electrical connection of said cover plate is a connector with attached wires compatible with the Serial Advanced Technology Attachment (SATA) standard.

9. The system as claimed in claim 7, wherein said cable is compatible with the Serial Advanced Technology Attachment (SATA) standard, and further comprises a socket formed at each end thereof, and said socket is capable of selectively mating with one of said electrical connection of said cover plate and said part device.
